(19) United States
(12) Patent Application Publication
(10) Pub. No.: US 2010/0199555 A1
(43) Pub. Date: Aug. 12, 2010

(54) Urban Farm/The Urban Garden

(76) Inventor: Edward L. Pole, Humble, TX (US)

Correspondence Address: WILSON DANIEL SWAYZE, JR., 3804 CLEARWATER CT., PLANO, TX, 75025, US

(21) Appl. No.: 12/367,506

(22) Filed: Feb. 7, 2009

(51) Int. Cl. A01G 31/00

(52) U.S. Cl. 47/62 R

(57) ABSTRACT

A growing system for growing plants may include a nutrient container for containing nutrient fluid; a first plant container for growing the plants in the nutrient fluid; and at least a second plant container for growing the plants in the nutrient fluid. The first plant container and the second plant container may be connected by a communication passageway and the first plant container may include a float sensor switch to detect an overflow of the first plant container. The first plant container may include a return pump device, and the first plant container and the second plant container may include a mesh insert. The nutrient container may include a Y valve device, and the nutrient container may include a reservoir pump device. The nutrient container may include a first timer device for delivering the nutrient fluid to the first plant container, and the nutrient container may include a second timer device for returning the nutrient fluid. The nutrient container may be connected to the first plant container by a fill and return passageway, and the nutrient container may include a float valve device. The nutrient container may include an anti-siphon valve and an anti-siphon failsafe check valve.

### FIELD OF THE INVENTION

This invention relates generally to greenhouse agriculture but more specifically to a hydroponic agricultural unit.

### BACKGROUND

Recent advances in the study of plants and agriculture have yielded new methods of making plants grow. Generally, it has been found that water that is highly saturated with nutrients is as effective if not more than traditional soil based agriculture. This new method is known generally as hydroponic culture. It is well known that hydroponic devices have existed for some time, are widely commercially available, and are an effective means to provide predetermined nutrient delivery amounts and rates of feed to cause accelerated plant growth in limited spaces. The following are some examples of prior art hydroponic devices: U.S. Pat. Nos. 5,394,647; 5,287,652; 4,926,585; 4,310,990; 4,279,101; and 4,211,034. It is also well known that many of these devices have been awkward to use, dedicated to only one type of growth method, incapable of pumping and evacuating their liquid contents thus limiting use location, void of pressure equalizing plumbing thus requiring greater pump pressure for a given system size, of limited modularization or not comprised of readily available off the shelf components, and lacking the ability to self clean. In particular, U.S. Pat. No. 5,394,647 discloses a self contained hydroponic device, yet such device is shown and described to have plumbing lines or tubes outside of the main body of the device.

Other United States patents include:

U.S. Pat. No. 7,181,886 discloses an hydroponic/aeroponic agricultural unit that involves sealing the plants in a highly water saturated environment which more closely recreates the feel of natural rainwater. Also, this invention features the ability of quickly changing from a small housing into a larger housing by varying the diameter of a drum so that a small drum can act as a nursery for seedlings. Once the seedlings have turned into plants, the drum is made larger. The plurality of planks making up the drum can be positioned close to the lamp when they are small and farther away when larger. A simple yet reliable system allows for the rotation of the drum.

U.S. Pat. No. 6,247,268 discloses an improved hydroponic device being an invention that because of its unique design, is readily constructed by mostly standard off the shelf components. The invention is self contained, self cleaning, adjusts to various grow methods, is capable of pumping and evacuating it's liquid contents, employs a pressure equalizing liquid harness and unique quick insert and quick release plant support baskets, and is modularly expandable.

U.S. Pat. No. 5,067,275 discloses a hydroponic garden utilizing conventional flower pots for growing chambers and a plastic PVC pipe supporting the flower pots through openings in the upper wall of the pipe so that a nutrient solution circulating through the plastic pipe feeds the plants growing in the flower pots. A timer controlled pump circulates the nutrient solution from a reservoir through the conduit and back to the reservoir according to a predetermined program.

U.S. Pat. No. 4,437,364 discloses a method of supplying nutrient liquid to a plant growing system comprising a series of many planters that are essentially alike and that are disposed at a common level, the system including a supply line extending from a supply point to the planters in succession, including the steps of first supplying a first nutrient liquid to the supply line at the supply point under pressure so that the planters receive nutrient liquid to progressively lower levels in relation to their distances from the supply point due to attenuation of pressure along the supply line, interrupting the supply of liquid for equalizing the levels of liquid in the planters, thereafter supplying a second nutrient liquid different from the first at the supply point so that the planters receive such second nutrient liquid to progressively lower levels in relation to their distances from the supply point, and interrupting the supply of the second liquid for equalizing the levels of liquid in the planters, thereby to develop a range of different nutrient liquids in the successive planters.

### SUMMARY

A growing system for growing plants may include a nutrient reservoir for containing nutrient fluid; a first plant container for growing the plants in the nutrient fluid; and at least one successive plant container for growing the plants in the nutrient fluid.

The first plant container and the second plant container may be connected by a communication passageway and the first plant container may include a float sensor switch to detect an overflow of the first plant container.

The first plant container may include a return pump device, and the first plant container and the successive plant container may include a mesh insert.

The nutrient reservoir may include a Y valve device, and the nutrient reservoir may include a reservoir pump device.

The nutrient reservoir may include a first timer device for delivering the nutrient fluid to the first plant container, and the nutrient container may include a second timer device for returning the nutrient fluid.

The nutrient reservoir may be connected to the first plant container by a fill and return passageway, and the nutrient container may include a float valve device.

The nutrient reservoir may include a reservoir float valve, and the nutrient container may include an anti-siphon valve.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the system of the present invention;

FIG. 2 illustrates a sectional view of the timers of the nutrient container;

FIG. 3 illustrates a perspective view of the plant container of the present invention;

FIG. 4 illustrates a perspective view of the system of the present invention;

FIG. 5 illustrates a sectional view of the valves of the nutrient container;

FIG. 6 illustrates a partial exploded view of the system of the present invention;

FIG. 7 illustrates a perspective view of the first container of the present invention;

FIG. 8 illustrates a perspective view of the valves of the present invention.

### DETAILED DESCRIPTION

The present invention is a recirculating hydroponic professional greenhouse technology provided in a user-friendly package for home vegetable production. The present invention may bring explosive, high yield hydroponics to porches, patios, decks, balconies, rooftops, atriums and greenhouses. The present invention allows people with little or no garden experience to harvest gourmet vegetables which may be the best they've ever tasted. This gardening experience may be obtained right outside the back door of their home with no weeding, tilling or soil borne diseases. The present invention may use 32, 44, or 55 gallon nutrient reserve which may be connected to a series of 3 gallon planters with mesh inserts. Nutrient fluid may be delivered from the reservoir to the planters by a timer controlled pump. A second timer controlled pump within one of the planters returns the nutrient fluid to the reservoir. The present invention employs a fill cycle and return cycle. The design allows the planters to sit at substantially the same level as the reservoir. This aspect may be important for some vegetables such as tomatoes and to cucumber plants which may reach 10-12 feet tall.

The nutrient fluid level may be maintained by a float valve which may be connected to the residential water supply. Water soluble nutrient may be added to the residential water supply in order to form the nutrient fluid. A growing medium such as rock wool may be loaded into mesh insert and placed inside the planters for the plants to grow in. A flexible tube connects the pump inside the reservoir of the first planter.

When the reservoir pump is active, nutrient fluid is pumped to the first planter and since all the planters are connected, the nutrient fluid is dispersed to all the planters. When the return pump in the first planter is active, the nutrient fluid is pumped to the reservoir from all the interconnected planters.

Since all the interconnected planters do not fill at exactly the same time, there may be a tendency for the first planter to overfill before the last connected planter can be filled. To prevent this, a fluid level sensor is operated with the first planter so that the fluid level sensor can prevent the first planter from overflowing. This will provide some time for the downstream planters to fill. The level sensor may be a vertical reed switch/doughnut float which may be operated with 12 V and mounted on a PVC riser on the outside of the first planter. The bottom of the riser may include a 90° elbow through a rubber grommet into the bottom of the first planter. As the nutrient fluid in the first planter begins to rise eventually, the water lifts the level sensor to open the circuit turning off the reservoir pump. The level sensor may be connected to a power supply and relay circuit which may be included within the first timer circuit which may control the power to the reservoir/delivery pump. When the level sensor has turned off the reservoir pump, the result of the interconnection of the planters tends to equalize the level of the nutrient fluid between the planters. This drops the level of the nutrient fluid within the first planter, and the level sensor will close allowing more nutrient fluid to flow into the first planter. All of the planter should eventually be equalized with nutrient fluid. Consequently, the failure of the timer which controls the reservoir pump should not result in the overflow of the planters due to the sensor which would inactivate the reservoir pump.

From time to time, it is necessary to drain the nutrient reservoir. An anti-siphon valve which may be located high inside the reservoir, is normally open and closed when the reservoir is drained. This anti-siphon valve prevents the fluid from being drained from the nutrient reservoir to the planters, and if the anti-siphon valve was left closed, the reservoir would drain when the nutrient fluid is added to the reservoir and the reservoir pump was activated. The anti-siphon check valve provides a backup failsafe, allowing energy to be sucked into the line to prevent the suction of the nutrient fluid. A Y valve which may be located below the timers, directs nutrient fluid between the reservoir and the planters or may be used to drain the nutrient fluid.

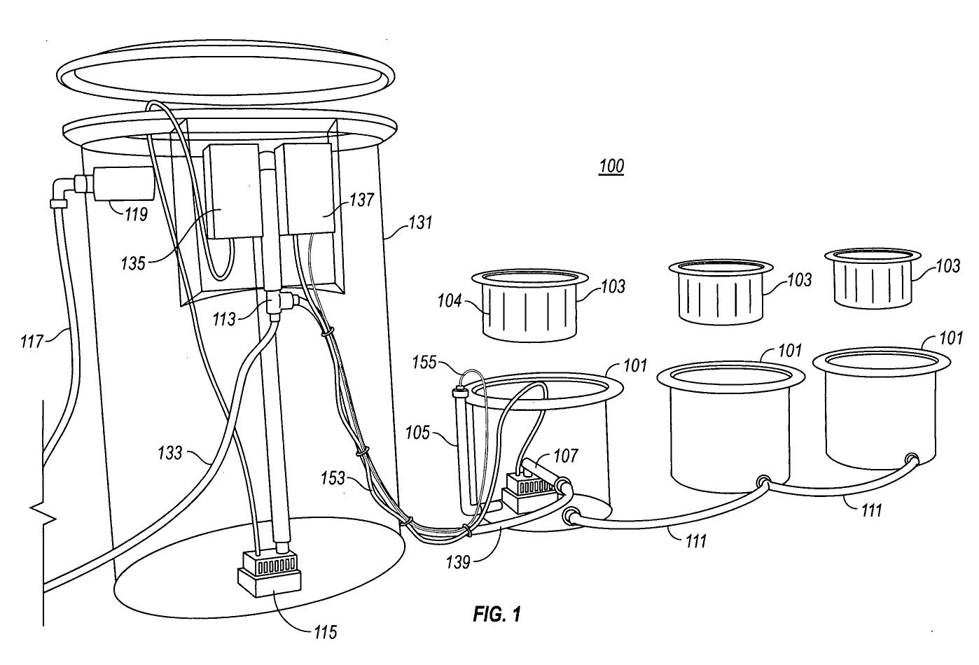

FIG. 1 illustrates a front view of the hydroponic system 100 of the present invention. The hydroponic system 100 may include a multitude of growing containers 101 which may be a cylindrical in shape and may be formed from rigid material. A plant mesh container 103 may be used to grow the plants and cooperate with the growing containers 100 and formed from a mesh insert. The plant mesh container 103 may include vertical slits 104 in order to allow fluid communication to allow the nutrients to flow into the plant mesh container 103. The growing container 101 may include an overflow device 105 to prevent the fluid from overflowing the growing container 101. The overflow device 105 vertically extends along the outer periphery of the growing container 101 to substantially the top of the growing container 101 and extends inward to within the growing container 101. The growing container 101 may include a return pump device 107 which may be connected to a feed and return passageway 139 to allow nutrient fluid from flowing to and from the nutrient reservoir container 131. Each of the growing containers 101 may be connected to another growing container 101 to allow the nutrient fluid to be exchanged between the connected growing containers 101 by a flexible connection passageway 111.

FIG. 1 additionally illustrates that the feed and return passageway 139 is connected to a Y valve device 113 which is connected to a drain passageway 133. FIG. 1 additionally illustrates that a first timer device 135 and a second timer device 137 are mounted on the exterior surface of the nutrient container 131. The first timer device 135 provides for time delivery of the nutrient fluid from the nutrient container 131, and the second timer device 137 provides for the time return of the nutrient fluid from the growing containers 101. The nutrient container 131 may include a reservoir pump device 115 to deliver nutrient fluid to the growing containers 101. The reservoir pump device 115 cooperates with the first timer device 135 to deliver the nutrient fluid to the growing device 101. The nutrient container 131 may include a float valve device 119 which may be connected to a fill passageway 117 to allow tap water to flow into the nutrient container 131, and the float valve device 119 may shut off the flow of tap water from the fill passageway 117 when the nutrient fluid reaches substantially the top of the nutrient container 131.

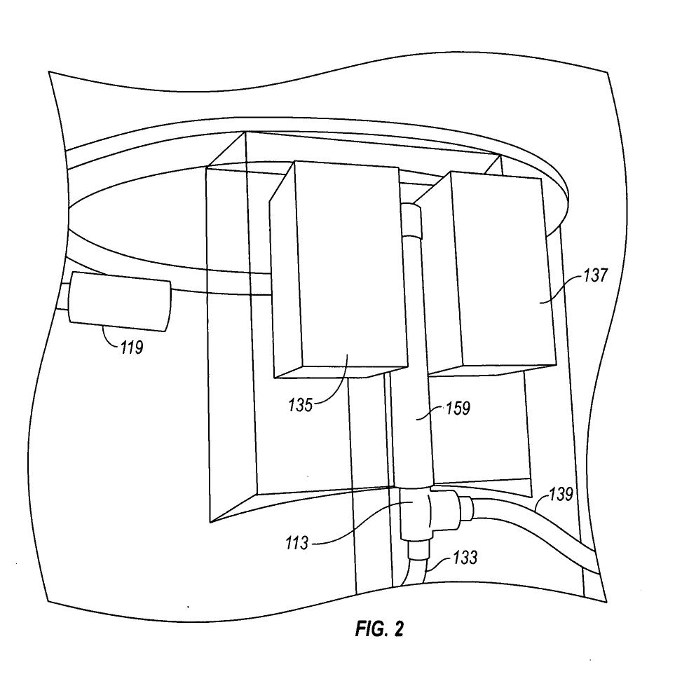

FIG. 2 illustrates a perspective view of the exterior of the nutrient container 131 and illustrates the first-timer device 135 and the second timer device 137 which may be connected to the Y valve device 113. FIG. 2 additionally illustrates the float valve device 119.

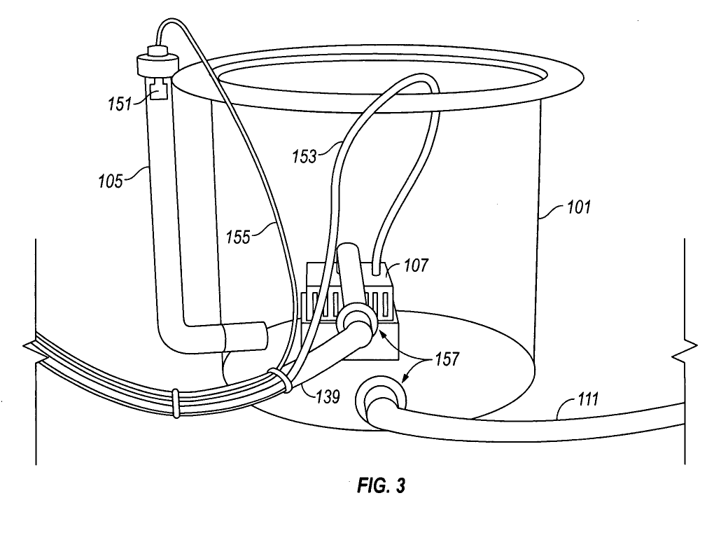

FIG. 3 illustrates a perspective view of the growing container 101 which may include a return pump device 107 which may be connected to the fill and return passageway 139 to fill and empty the growing container 101 of nutrient fluid. FIG. 3 additionally illustrates the overflow device 105 which may contain a fluid level float sensor 151, which is connected to timer 135 by a 12 volt power cord 155. FIG. 3 additionally illustrates a pump cord 153 and a grommet device 157 to allow for a watertight connection for the connection passageway 111. FIG. 3 additionally illustrates a rubber grommet 157 is also used for a water-tight connection to passageway 111 and all succeeding growing containers 101.

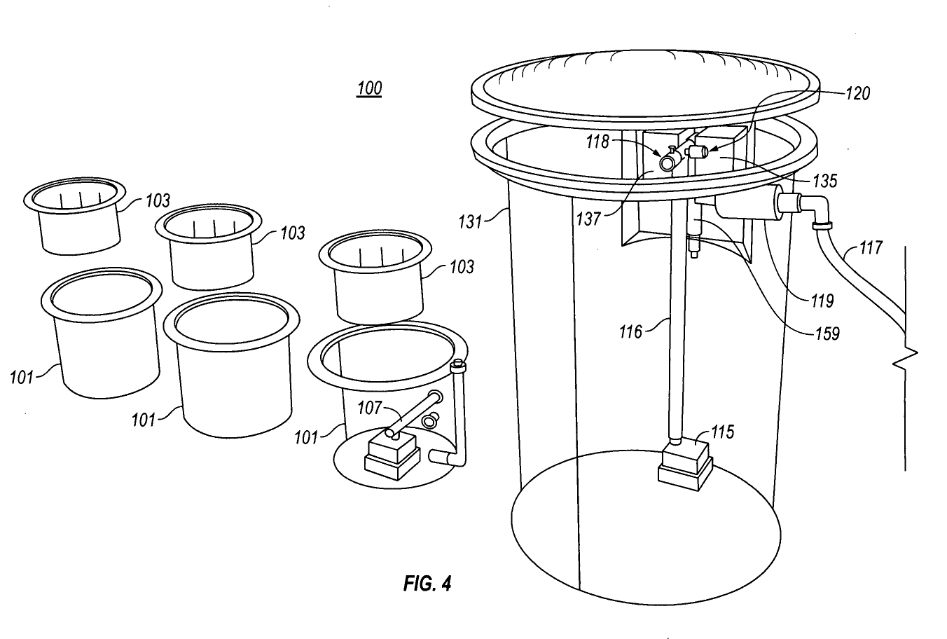

FIG. 4 illustrates a back view of the hydroponic system 100 and illustrates the growing containers 101 and the mesh insert containers 103. Furthermore, FIG. 4 illustrates the return pump device 107. FIG. 4 illustrates the nutrient reservoir container 131 which may include the first timer device 135 and the second timer device 137, and FIG. 4 illustrates the flow fill valve device 119 which may be connected to the fill passageway 117. FIG. 4 additionally illustrates the reservoir pump device 115 which may be connected to the central passageway 116 which may be connected to the anti-siphon valve 118 and the anti-siphon check valve 120 and the exterior passageway 159.

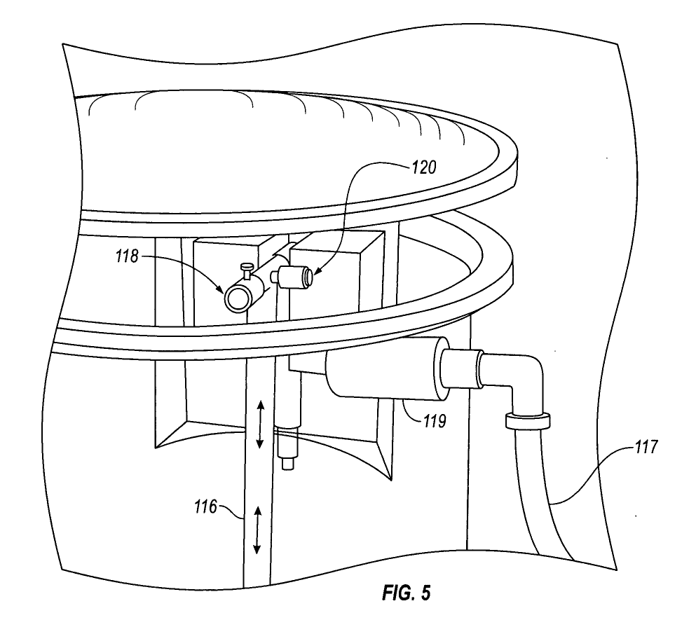

FIG. 5 illustrates the central passageway 116 which may be connected to reservoir pump device 115 (not shown) which may be connected to the anti-siphon valve 118 and the anti-siphon check valve 120. FIG. 5 additionally illustrates the float valve device 119 which may be connected to the fill passageway 117.

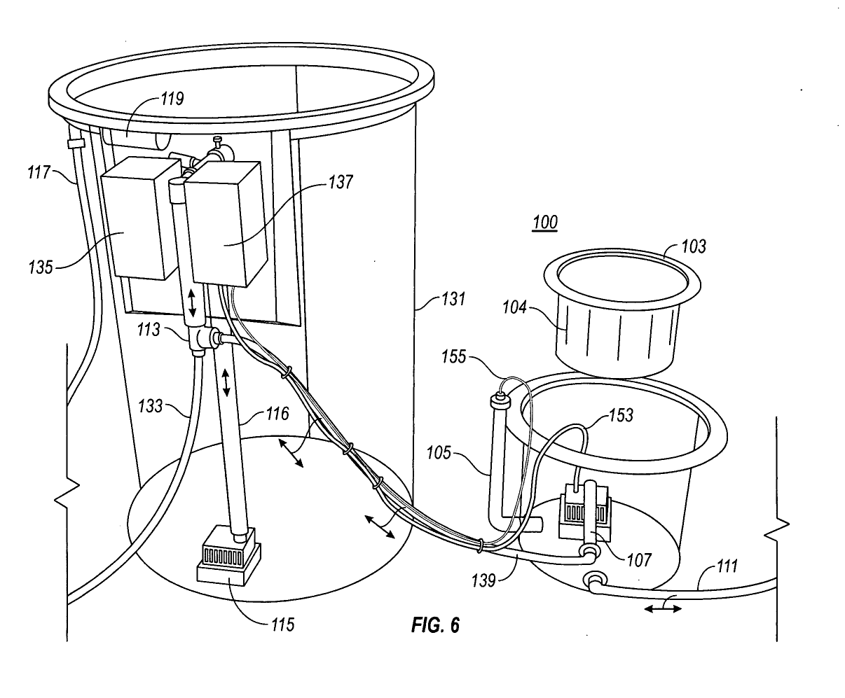

FIG. 6 illustrates a front view of the hydroponic system 100 of the present invention. The hydroponic system 100 may include a growing container 101 which may be cylindrical in shape and may be formed from rigid material. A plant mesh container 103 may be used to grow the plants and cooperate with the growing container 100 and formed from a mesh insert. The plant mesh container 103 may include vertical slits 104 in order to allow fluid communication to allow the nutrients to flow into the plant mesh container 103. The growing container 101 may include an overflow device 105 to prevent the fluid from overflowing the growing container 101. The overflow device 105 vertically extends along the outer periphery of the growing container 101 to substantially the top of the growing container 101 and extends inward to within the growing container 101. The growing container 101 may include a return pump device 107 which may be connected to a feed and return passageway 139 to allow nutrient fluid from flowing to and from the nutrient reservoir container 131. Each of the growing containers 101 may be connected to another growing container 101 to allow the nutrient fluid to be exchanged between the connected growing containers 101 by a flexible connection passageway 111.

FIG. 6 additionally illustrates that the feed and return passageway 139 is connected to a Y valve device 113 which is connected to a drain passageway 133. FIG. 6 additionally illustrates that a first timer device 135 and a second timer device 137 are mounted on the exterior surface of the nutrient container 131. The first timer device 135 provides for time delivery of the nutrient fluid from the nutrient container 131, and the second timer device 137 provides for the time return of the nutrient fluid from the growing containers 101. The nutrient container 131 may include a reservoir pump device 115 to deliver nutrient fluid to the growing containers 101. The reservoir pump device 115 cooperates with the first timer device 135 to deliver the nutrient fluid to the growing device 101. The nutrient container 131 may include a float valve device 119 which may be connected to a fill passageway 117 to allow tap water to flow into the nutrient container 131, and the float valve device 119 may shut off the flow of the tap water from the fill passageway 117 when the nutrient fluid reaches substantially the top of the nutrient container 131.

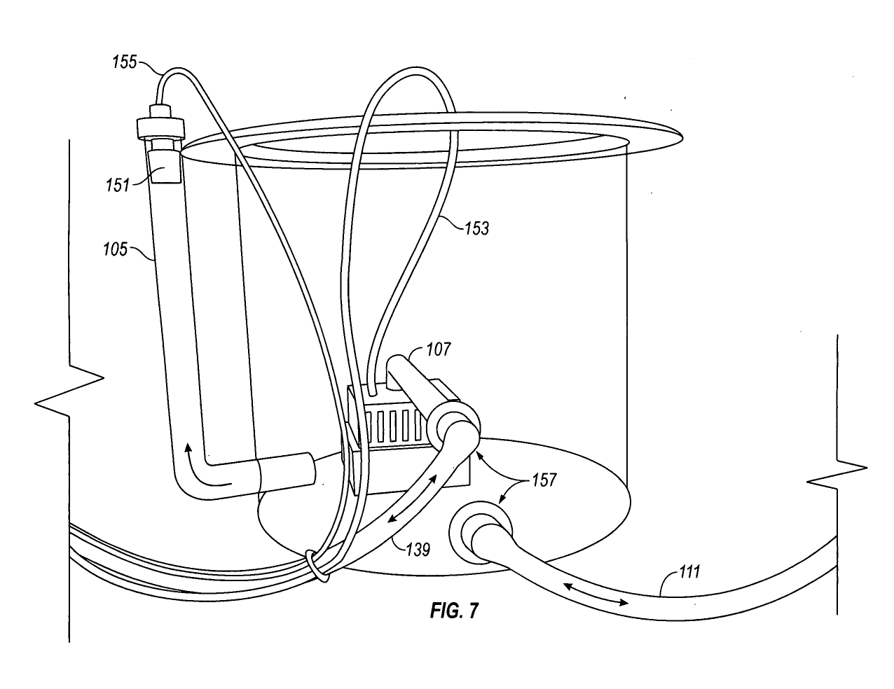

FIG. 7 illustrates a perspective view of the growing container 101 which may include a return pump device 107 which may be connected to the fill and return passageway 139 to fill and empty the growing container 101 of nutrient fluid. FIG. 7 additionally illustrates the overflow device which may include ns the fluid level sensor 151 which may be connected to a 12 volt power cord 155 to control the level of nutrient fluid within the growing container 101.

FIG. 7 additionally illustrates two grommet devices 157 to allow for a watertight connection for the connection passageway 111, 139.

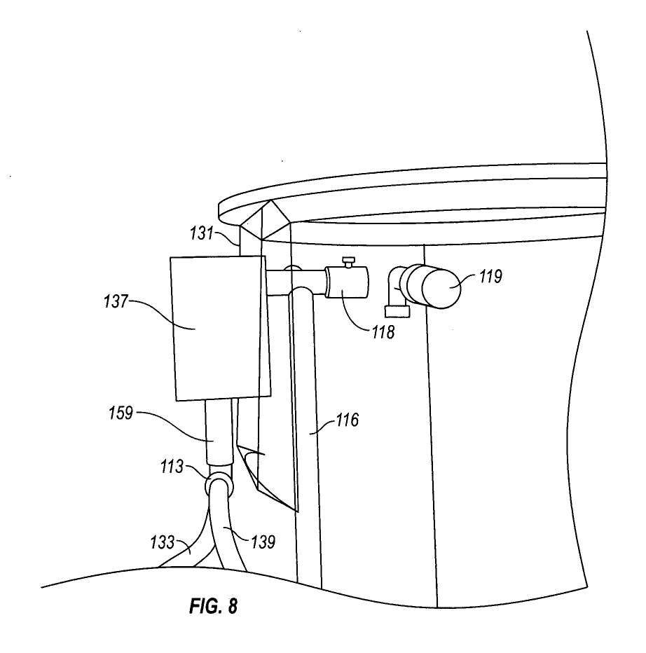

FIG. 8 illustrates a side view of the nutrient container 131 and illustrates the second timer device 137. The common passageway 159 is connected to the anti-siphon valve 118 and is connected to the Y valve device 113 which is connected to the drain passageway 133 and the fill and return passageway 139. The nutrient container 131 includes a reservoir float valve device 119 to substantially maintain fluid level in the nutrient reservoir from tap water supply 117.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A growing container for growing plants, comprising:
a nutrient container for containing nutrient fluid;
a first plant container for growing the plants in the nutrient fluid;
a second plant container for growing the plants in the nutrient fluid;
wherein the first plant container and the second plant container are connected by a communication passageway;
wherein the first plant container includes a float sensor switch to detect an overflow of the first plant container;

2. A growing container for growing plants as in claim 1, wherein the first plant container includes a return pump device.

3. A growing container for growing plants as in claim 1, wherein the first plant container and the second plant container include a mesh insert.

4. A growing container for growing plants as in claim 1, wherein the nutrient container includes a Y valve device.

5. A growing container for growing plants as in claim 1, wherein the nutrient container includes a reservoir pump device.

6. A growing container for growing plants as in claim 1, wherein the nutrient container includes a first timer device for delivering the nutrient fluid to the first plant container.

7. A growing container for growing plants as in claim 1, wherein the nutrient container includes a second timer device for returning the nutrient fluid.

8. A growing container for growing plants as in claim 1, wherein the nutrient container is connected to the first plant container by a fill and return passageway.

9. A growing container for growing plants as in claim 1, wherein the nutrient container includes an anti-siphon failsafe check valve.

10. A growing container for growing plants as in claim 1, wherein the nutrient container includes a reservoir float valve.

11. A growing container for growing plants as in claim 1, wherein the nutrient container includes an anti-siphon valve.
